(19) United States
(12) Patent Application Publication
(10) Pub. No.: US 2007/0276951 A1
(43) Pub. Date: Nov. 29, 2007

(54) Apparatus and method for efficiently and securely transferring files over a communications network

(76) Inventors: Nicholas Dale Riggs, Leeds, AL (US); David Allen Sanders, Kimberly, AL (US); Michael Douglas Rhodes, Alabaster, AL (US)

Correspondence Address: SIROTE & PERMUTT, P.C., P.O. BOX 55727, 2311 HIGHLAND AVENUE SOUTH, BIRMINGHAM, AL, 35255-5727, US

(21) Appl. No.: 11/440,868

(22) Filed: May 25, 2006

(51) Int. Cl. G06F 15/16

(52) U.S. Cl. 709/229; 709/219

(57) ABSTRACT

A system and method to reduce the time to transfer files from one computer to another over a communications network, such as the Internet, through a client/server architecture includes a sending client, a receiving client, and a repository system. The sending client logs into the server and transmits data such as receiving names and information about a file to the repository system. The repository system directs the sending client to send the file to the repository system. The file that is intended to be transferred from a sending client to a receiving client is partitioned into multiple block portions of the existing file, prior to transfer. Each block subportion of original file is compressed and queued for transmission to the repository system. The compressed blocks are kept in a cue, encrypted, and transmitted asynchronously to the repository system over a selected communications network.

This application claims the benefit of filing priority under 35 U.S.C. §119 and 37 C.F.R. §1.78 of the co-pending U.S. Non-Provisional application Ser. No. 11/133,957 filed May 20, 2005, Ser. No. 10/434,824 filed May 9, 2003, for an Apparatus and Method for Efficiently and Securely Transferring Files Over a Communications Network which depends from Provisional Application No. 60/460,443 filed Apr. 4, 2003. All information disclosed in those prior applications is incorporated herein by reference.

### FIELD OF THE INVENTION

The present invention relates generally to file transfer systems for transferring files from one computer to another. In greater particularity, the present invention relates to a Java-enabled web interface for transferring compressed and encrypted files over a communications network.

### BACKGROUND OF THE INVENTION

Many users require file transfer to support data replication, ETL/data warehouse projects, offsite storage and content delivery. The size and frequency of such transfers requires an increasing demand for time on networked systems. Moreover, the information must be easily accessed, analyzed and exploited by users so that users may share vital information with their partners, distributors, employees, and the public. The challenge is to ensure the collected data—for example, from a local office, desktop or district center server is transferred to or from quickly, in a secure, reliable fashion while optimizing bandwidth. The means used to transfer the data should provide speed, security, reliability, and scalability. In many applications for file transfer, speed is often sacrificed for security, or reliability is sacrificed for cost or convenience. Bandwidth consumption is often the most critical issue and the only option is to buy access to more bandwidth.

The file sizes and amount of data currently being transferred are exponentially larger than just a couple of years ago. Enterprise level system administrators are not alone in the need for these capabilities. Medium and small businesses, as well as home desktop users are also facing critical file transfer issues. Typically desktop users have increasingly relied on e-mail as their de facto file transfer tool—it's readily accessible and easy to use. However, e-mail was never intended for use as a file transfer tool and is ill-suited for the purpose. The evolution of the corporate environment to a distributed workforce with a myriad of disparate networks and multiple desktop/server platforms adds further complexity to the extensive list of additional requirements such as: transfers from one to many, or many to one, secured identities, ease of scalability, role level access, robust audit trails, cross platform capability, desktop agnostic capability, simple rule set propagation, confirmation of transfers and verification, of transfer completion and automated fire and forget features.

### SUMMARY OF THE INVENTION

An aspect of the invention provides a file transfer system including a first server configured to communicate with a first client to direct an asynchronous file transfer from said first client to a second client such that the file to be transferred is divided into a plurality of file parts; and a second server configured to receive said plurality of file parts asynchronously and store said file parts for access by said second client.

### BRIEF DESCRIPTION OF THE DRAWINGS

FIG. 1 is a diagrammatic view showing the transmitting environment of the invention utilizing known communications networks to transfer files from one location to a single or a plurality of targeted receiving computers;

FIG. 2 is a process flow diagram showing the primary steps for preparing and transmitting a file from a transmitting computer utilizing the invention;

FIG. 3 is a process flow diagram showing the primary steps in establishing an encryption protocol with a receiving computer from the source transmitting computer;

FIG. 4 is a process flow diagram showing the primary steps in receiving and decoding a transmitted file at the receiving computer in accordance with one embodiment of the invention;

FIG. 5 is a process flow diagram showing the primary steps in receiving and decoding a transmitted file at the receiving computer in accordance with a second embodiment of the invention;

FIG. 6 is an object function diagram showing the primary processes and functions of the invention;

FIG. 7 is a high-level architectural diagram for a Java-enabled system according to an aspect of the invention;

FIG. 8 is a diagram of a core library for the server and desktop applications according to an aspect of the invention;

FIG. 9 is a high level architectural diagram of a desktop client of FIG. 7 according to an aspect of the invention; and

FIG. 10 is a high level architectural diagram of a server side repository system of FIG. 7 according to an aspect of the invention.

### DESCRIPTION OF THE PREFERRED EMBODIMENTS

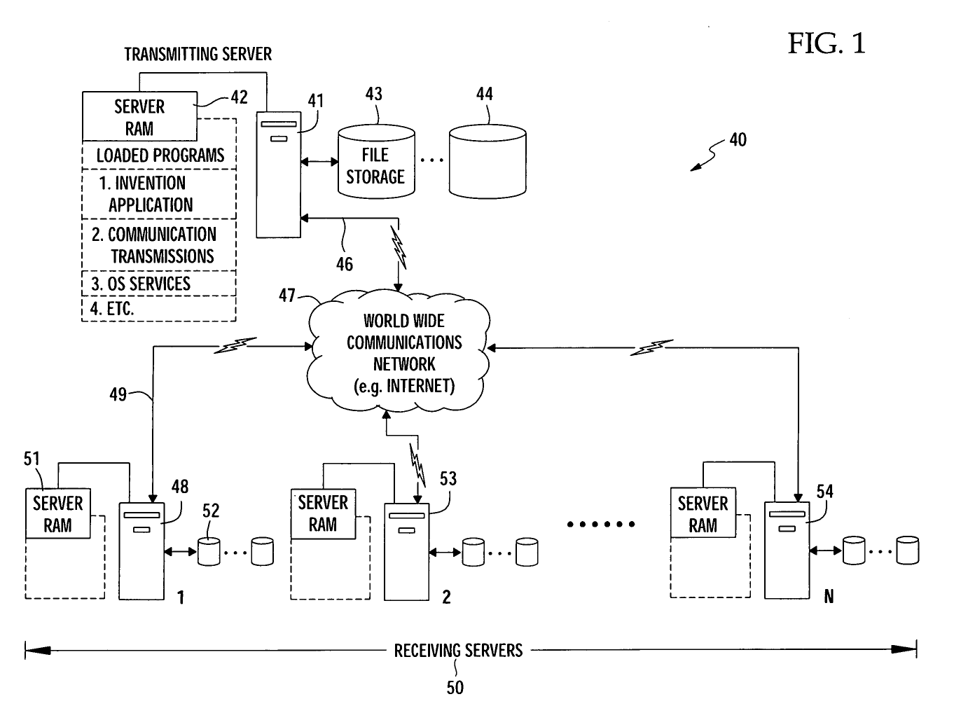

Referring to FIG. 1, one may see a typical communications environment in which the present invention would operate. A transmitting server 41 running a standard operating system, such as Windows 2000 or Windows XP, will have loaded programs in its RAM 42 providing a multiplicity of services and system extensions upon which the present invention relies. For example, the disclosed system is designed to be an OS portable application, but currently runs under Windows 2000 operating system, or later, including XP. In file transfers in which the communications medium connecting the transmitting computer with a target receiving computer utilizes the Internet, IIS 5.0+ (Internet Information Services) is initiated to: (1) supply or host a multitude of HTTP communications channels with a remote target receiving server, including supplying current communications parameters back to the invention; (2) keeping track of “receiver objects” as file transfer jobs are prepared for transmission; and (3) process each block transmission. The invention is created using the Microsoft .NET Framework which coordinates command exchanges between the Windows operating system and IIS. An SQL Server 2000 or MSDE (Microsoft Data Engine) is also utilized to record the current status of the invention (e.g. current settings), including the status of each file transmission in progress. In the event of a computer disruption, the current operation can be resumed without loss of data and transmissions automatically resumed. In as much as communications systems under Windows environments, such as 2000 and XP, are well understood and not necessary for a complete understanding of the herein described invention, further explanations of the workings and operations of the Windows platform OS and its inherent capabilities to communicate over the Internet with a target computer site will be omitted.

A transmission portion of the herein disclosed invention is loaded on computer server 41 and operates within the server ram 42 to administer the transmitting of files from transmitting server 41 to one or more receiving servers 50. File storage 43, which may or may not be scaled to associated file storage subsystems 44, interacts with transmitting server 41 to hold interim portions of transmission blocks and files in preparation for transit. Transmitting server 41 communicates over standard communication lines 46, such as, for example, dial-up, broadband, T1, T3, ISDN and other types of communication systems. It will be understood by those skilled in the art that communication conduit 46 is independent of the herein described system and method. Further, the herein described example 47 of the Internet as a medium to provide communications between a transmitting server and one or more receiving servers 50 is simply for illustration purposes and any form of communications network will operate suitably with the herein described invention, such as, Ethernet communication networks, Token Ring communication networks, optical fiber networks, radio communication based networks, microwave transmission networks, wide area networks, various other forms of proprietary local area networks, and hard wired buses.

Receiving servers 50 may be as few as one, or as many as needed to effectively broadcast a file to a preselected set of receiving computer servers. First receiving computer server 48 has loaded in its ram 51 an operating system suitable configured to communicate with remote computer systems running the operating system loaded in transmitting server RAM 42. A second portion of the herein disclosed invention is loaded in server RAM 51 to process portions of blocks received by receiving server 48 in order to effectively decrypt, decompress, and reconstitute an original file, pursuant to the herein disclosed procedures. Disk memory substances 52 as with transmitting server 41 may be locally connected to receiving server 48 or may be remotely connected via known memory subsystem communications protocols. The method by which receiving server 48 is connected to transmitting server 41, for example in this case via conduit 49 through the Internet 47, is unimportant except from the standpoint that the connecting communications network must be capable of supporting the transmission protocols utilized by the communications programs loaded in the transmitting server and receiving server RAM, which is most likely a function of services offered by a selected operating system. As will be shown, while significant gains can be achieved for file transfers between a single transmitting server and a single receiving server 50, additional gains in file transmission performance can be achieved when broadcasting a particular file to a multiplicity of receiving servers 50.

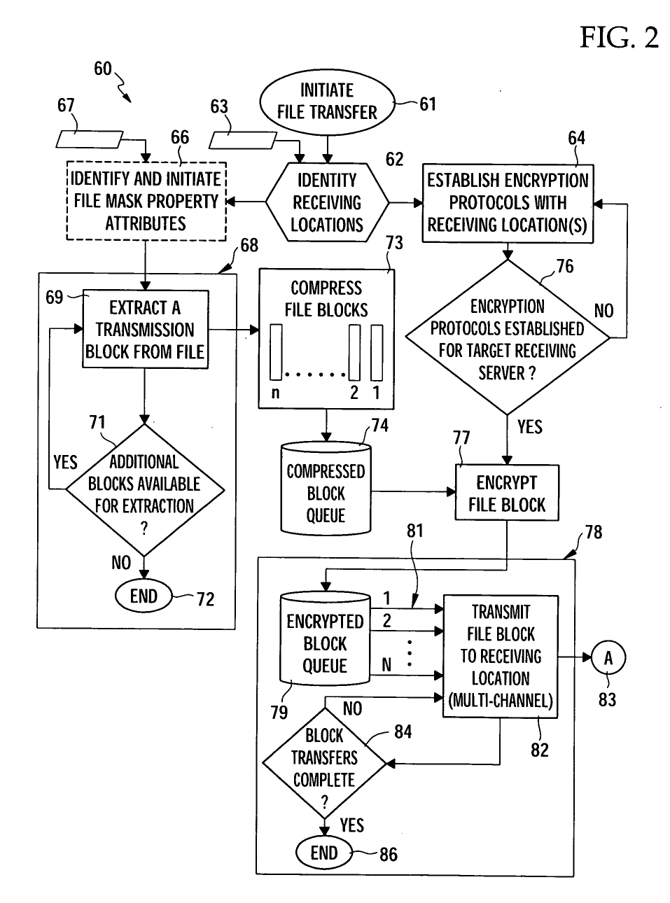

Referring now to FIG. 2, the overall process flows of the herein described invention may be seen at the transmitting server location. To initiate a file transfer 61, various types of user interfaces and/or mechanisms may be incorporated. Well-known graphical user interfaces exists for dragging and dropping files from one folder to another, in, for example, FTP applications from one computer to another computer communicating over the Internet. Hence, while certainly a command line alpha numeric command structure may be utilized to initiate a file transfer, graphical user interfaces could more likely be utilized to drag and drop files from one folder to another where one of the folders can be located on a receiving server remotely located from the transmitting server. Moreover, a particular folder or directory location could through a masking or background function 66 identify multiple locations, akin to a fax broadcast message, in which several receiving server locations are identified. Such masking 66 and data 63 can identify one or more receiving locations 62 and initiate the establishing of encryption 64 protocols for transmitting file data to a targeted receiving server location. The herein described invention can utilize both of a direct identification method and a masking identification method to initiate a file transfer and direct the transfer to a particular receiving computer or set of computers. The herein described invention may integrally combine encryption within the overall system operation, as noted above, but those skilled in the art will understand after a viewing the herein described process that both the encryption and masking sub-processes of the herein described invention are not critical to the core operation of the invention and may be removed from the overall process without affecting the overall goal of file transmission or the transmission time improvements discussed above. Once receiving locations 62 are identified and file mask properties and attributes are identified 66 for each particular file initiated for transfer, the file to be transferred is passed to a block extraction subprocess 68. An extraction routine 69 extracts a 2 MB portion of the file to be transferred and passes the extracted block to an asynchronous file compression process 73. For the purposes of this disclosure and for better clarity, a “block” is defined as an extracted sub-portion or subset portion of a file to be transmitted to the receiving computer. While a 2 MB sized block is currently utilized by the inventors and appears to be an optimal extraction size for today's file transfers utilizing today's Internet communication conduits, it is expected that the size of each extraction block will vary by system and evolve over time to accommodate various types of system configurations and communications environments. Further, the invention herein anticipates that this extraction block size could be intelligently varied to accommodate various types of preselected parameters, and/or manually configured parameters to optimize file transmission speed. If the file to be transferred is less than 2 MB, in the herein described example, then a single 2 MB block, or less, would be passed to the file compression function 73, thereby exhausting the contents of a selected file. Additional 2 MB blocks are extracted from the file asynchronously until all of the available blocks have been extracted from the file to be transferred 71. Asynchronously with the extraction operation from module 68, extracted blocks are passed to compression utility 73 and each block is asynchronously compressed in accordance with a preselected compression utility that is invoked by the transmission subsystem 60 of the herein described invention. Various types of compression utilities may be utilized in the herein describe invention and the inventors anticipate that as compression utilities improve that those compression utilities could be incorporated into the herein disclosed invention as desired. The current compression utility utilized by the inventors is referred to in the industry as “G-Zip” and allows for rapid compression and decompression asynchronously of file blocks. Compression 73 occurs on blocks serially, although asynchronously, as received from extraction subsystem 68 and each compressed block is then queued 74 in temporary storage in preparation for file encryption 77. As stated above, this encryption is not necessary for the herein described invention to operate, however, encryption is useful and desirable for most corporate communications over nonsecure networks such as the Internet.

In order for the transferring computer server to establish a proper encryption protocol with the receiving computer, a set of standard security keys must be exchanged to allow for efficient encryption and decryption of received file blocks. Normally, encryption protocols would be established with the target receiving computer 64 quite rapidly and precede the completion of file block compression by a comfortable time margin. However, should encryption be an inherent component to the system and encryption protocols have not yet been established with the target receiving server, then file block transmission could be delayed until file block encryption can proceed at step 77.

While the file transfer process depicted in FIG. 2 is the preferred embodiment, a slightly altered process flow may have advantages. As shown in the figure, the extracting of blocks in subprocess 68 is initiated before individual blocks are compressed 73, and then encrypted 77. However, while these steps are occurring asynchronously with respect to one another, the inventors also envision the overall system 60 in which either encryption and compression subprocesses might be initiated prior to the initiation of the file block extraction process. For example, an individual file might be compressed 73 after the file mask subprocess 66 completes, with block extraction and encryption occurring after file compression. Further, a file might be encrypted prior to either extraction or compression. This might provide advantages in the overall process by allowing a more definitive file transfer size to be known prior to extraction and transmission, thereby allowing better block size optimization and faster data transmission. Also, a higher level of security is provided if the extraction process is to be carried out on unsecured hardware, such as for example at a remote distributed processing location.

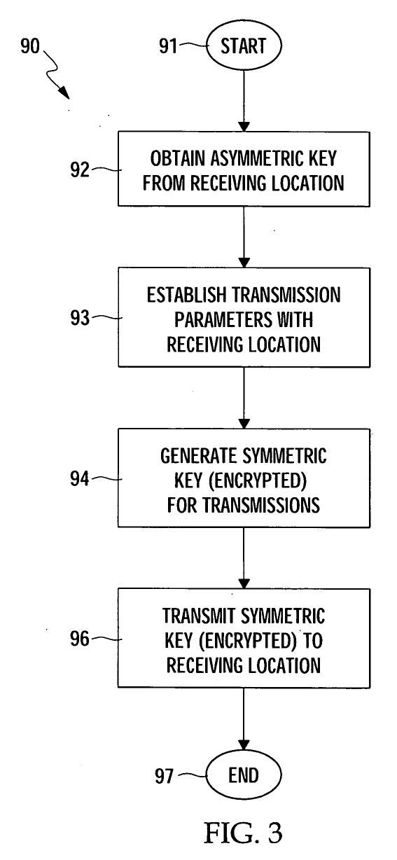

Referring now to FIG. 3 a standard establishment of encryption protocols under step 64 is further explained. Upon identification of the target receiving computer server 91, an asymmetric key is obtained from the receiving location 92 and a common security protocol for transmission parameters is established with the target receiving location 93. The transmitting computer server then generates a symmetric key for transmission 94, sometimes referred to as a “session key,” and the symmetric key is then encrypted utilizing the public asymmetric key obtained from the target receiving location. The encrypted symmetric key is then transmitted 96 to the target computer receiving location to enable rapid decryption of any received file blocks at the receiving computer server in accordance with the established security transmission parameters. Once the encrypted symmetric key is transmitted to the receiving location, step 64 would be complete and encryption of file blocks 77 can proceed asynchronously with respect to both the extraction subsystem 68 and the compression sub-process 73. The encryption protocols established in step 64 are well-known standard security structures utilizing symmetric and asymmetric, public-private key exchanges, as are utilized in SSL and SHTTP communications. Various types of public-private key encryption algorithms exists and may be utilized in the herein invention. For example, RSA (Rivst Shamir Adleman) and ECDSA (a variant of DSA) may be utilized. Also, while the herein disclosed invention currently utilizes RC5 for symmetric encryption of the blocks transmitted, other types of symmetric encryption schemes may be utilized such as DES (Data Encryption Standard) or AES. Some symmetric key algorithms also require an initialization vector that may be supplied, in encrypted form, to a target receiving computer. Therefore, once the encryption protocols have been established 76, each file block queued 74 may be then encrypted 77 and passed to another queue 79 awaiting asynchronous transmission to a target computer receiving location.

Referring again to FIG. 2, it may be seen that multiple threads or channels are available to pass encrypted blocks from queue 79 to a transmission subprocess 82 to transfer blocks to target receiving computers 83. While encrypted blocks are queued in first-in-first-out (FIFO) format from encryption function 77, transmission subsystem 82 allows any available channel to obtain any available encrypted block in parallel 81 so that multiple simultaneous channels (e.g. 10) may continually transmit blocks to one or more target receiving server computers. Inventors have experienced some incremental performance increases by allowing multiple channels or multiple transmission threads to operate. As is shown, the order of transmission of any particular block is unimportant for the overall successful operation of the herein described invention since blocks are reassembled at their respective destinations in accordance with a final block naming convention, as will be described. Therefore, the order of transmittal of a particular block can proceed asynchronously and out of order with respect to any other process at the transmitting computer server.

In order to keep track of each file block being transferred within system 40, a file name convention has been established. Prior to block extraction subprocess 68, and preferably during step 66, the file to be transferred is renamed to annotate the suffix with an arbitrary time stamp string such as, for example, in the following:

TABLE 1

```
Starting file name: myfile.txt
New File Name: myfile_200304010908599512.txt
Where “200304010908599512” = yyyyMMddhhmmssffff as in:
    yyyy = year
    MM = month
    dd = day
    hh = hour
    mm = minute
    ss = second
    ffff = millisecond
```

Thereafter, each extracted file block adopts the file name convention identical to the initially applied name convention, but adds a period and a file block number within a five digit sequence as shown below:

$$myfile\_ 200304010908599512. . txt . F 0000$$

$$myfile\_ 200304010908599512. . txt . F 0001$$

$$myfile\_ 200304010908599512. . txt . F 0002$$

$$⋮$$

$$myfile\_ 200304010908599512. . txt . F 000 n$$

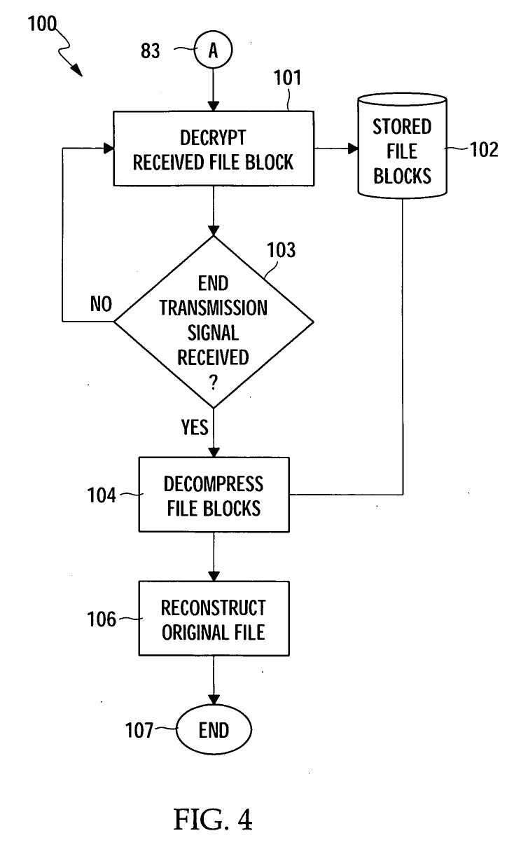

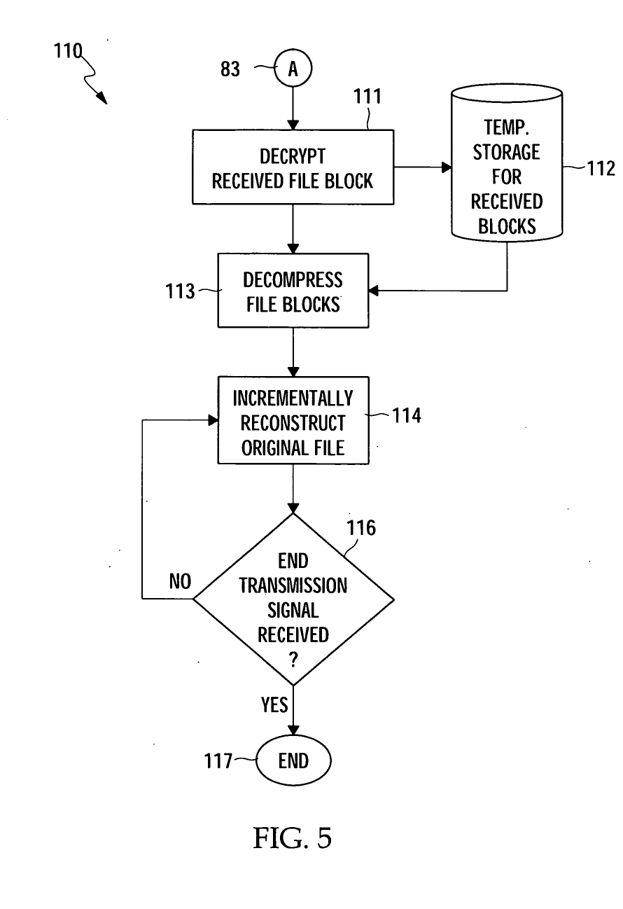

The reconstruction component of the herein described invention loaded on the target receiving computer server is, therefore, able to identify each received block in accordance with this naming convention and reassemble blocks in their proper sequence to recreate the original file as will be described further in FIGS. 4 and 5.

As each block is transmitted to target receiving locations 82, the transmission subsystem 78 checks to see if all blocks for a particular file have been transferred 84. If all blocks have been transferred successfully, the transmission subprocess 78 ends 86. Alternatively, transmission file block process 82 continues until all blocks are sent. Once the transmission subsystem 78 has finished transmitting all of the file blocks and the subprocess ends 86, an end transmission signal is transmitted to the target receiving computer server 83.

Referring now to FIGS. 4 and 5, a transmitted block 83 is received by target receiving computer server, decrypted 101, and stored in a file block memory location 102 for further processing. The receiving computer server continually looks for an end of transmission signal 103 and continues to decrypt file blocks until such a signal is received. Once the end of transmission signal is received, all of the stored file blocks 102 are decompressed 104 and reconstructed 106 into the original file utilizing the above described file block naming convention to properly order each block. Once the original file is reconstructed 106, recreation process 100 is ended 107 and the original file may be then moved to a preselected location pursuant to other user interface commands which may have been passed to the target receiving computer's management control portion of the herein described invention.

As shown in FIG. 5, another embodiment 110 of the herein described enclosed invention 110 is shown in which incremental reconstruction of the original file proceeds to obtain asynchronous progression of transmission and decompression phases of the herein described invention. Specifically, each received block is decrypted 111 and passed to a temporary storage location 112 for each decrypted file block. Asynchronously with regard to an encryption process 111, each file block is decompressed 113 as available from temporary storage location 112 and a dummy file is created by the system and filled with zeros to match the size of the original file. As each file block is decompressed 113, the system is knowledgeable as to its proper location within the dummy file stored on the receiving computer system. As each file block is decompressed, it is incrementally appended into the original file by overwriting an existing portion of the dummy file precreated by the process 110. The location onto which a particular file block is overwritten can be calculated since the size of each file block is pre-selected in the block extraction process, remaining consistent throughout the operation of the process, and the order relative to other blocks is established in the file suffix naming convention. The system continually checks for an end of transmission signal 116 and upon receipt of such a signal passes the reconstructed original file to an invention management program to save the original file in a preselected location dictated by properties controlled in step 66. By incrementally reconstructing the original file in an asynchronous manner, additional transmission performance gains can be realized.

While the inventors of the herein disclosed invention utilize a file suffix naming convention to govern the reconstruction of transmitted file blocks, other strategies are perfectly acceptable. For example, a separate transmission might be sent along with each block transmission to indicate its order relative to the other blocks, or each block transmission might include in its data stream an identifying portion that can be reclaimed at the receiving computer to indicate the blocks order relative to other received blocks. In fact, any identifying data that can be properly associated with a specific block transmission can be utilized to indicate to the file reconstruction sub-function its proper place in the asynchronously received group of blocks. Such ordering data indicia can even be based upon an inherent property of the transmitted block or be encoded within the block data itself. For the purposes of this disclosure, the term “ordering data indicia” is hereby defined as any purposeful data designed to provide information on the ordering relationship of the transmitted blocks to allow faithful reconstruction of the original file contents at the receiving computer.

Regardless of which reception and reconstruction method is utilized 100 or 110, transmission and reception of identical blocks at a plurality of receiving computers will improve realized transmission performance. Portions of transmission process 60 need execute only one time for a set of receiving computers, thereby allowing for a distribution of part of the process time for the operational steps shown in 60 over the range of receiving computers. While some additional transmission time in step 82 and some additional time may be required to establish security protocols, the time required to complete steps 61, 66, 68, 73, and 77, can be shared by all receiving computers. Therefore, each receiving computer will experience real overall transmission times reductions for any file broadcast to a multiplicity of receiving computers.

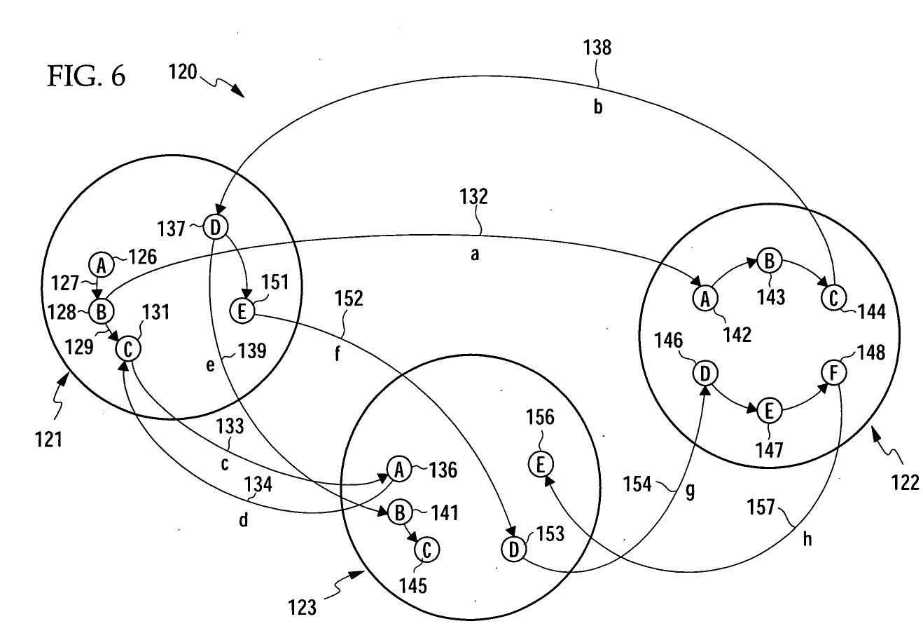

FIG. 6 shows the system object structure for the apparatus components 120 of the disclosed invention. A sender module 121 running on a transmitting computer server controls and initiates transmissions to a receiver module 123 running on a target receiving system. A compression manager module 122 combines a number of sub-processes, some running on the target receiving system and some running on the transmitting computer server, for controlling the compression and decompression of transmitted file blocks.

Sender module 121 includes a sub-function 126 that creates a transmission data set 127 for holding the state of any particular transmission job and for re-instituting an interrupted transmission job. Sub-function 128 examines file attributes of the file selected for transmission to determine if existing predefined rules automatically identify target receiving locations to which the file should be transmitted. The file name and location is passed 132 by the file attribute sub-function 128 to the compression manager module 122 for further segmentation and compression processing of the file. Any identified target receiving locations 129 are passed to a transmission initiator 131 that retrieves asymmetric key information from the target receiving location(s) and generates the proper symmetric keys for use during file transmission. These keys govern the encryption and decryption sub-functions in the sender and receiver modules 121, 123 during block transmissions. Encryption information 133-134 is exchanged with the receiver module 123 via receiver sub-function 136 residing on all of the target receiving computers. An encryption sub-function 137 in sender module 121 utilizes the public key retrieved by sub-function 131 to encrypt any blocks 138 compressed in sub-module 122 and to transmit the compressed, encrypted blocks 139 to a target receiving computer sub-function 141.

Compression manager sub-module 122 includes mirror sub-functions running on the transmitting server 142-144 and running on the target receiving computer 146-148. Sub-function 142 initiates a compression process by allocating memory to use as a buffer for the compression and instantiating a compression manager to manage the implementation of the G-Zip compression algorithms. Sub-function 143 extracts a 2 Mb file section from the identified file 132 and compresses it. Another sub-function 144 temporarily stores the extracted compressed file section in a temporary folder and coordinates with sub-function 137 for transmission of the block to the target receiving computer.

A transmission completion sub-function 151 monitors the transmission process in coordination with sub-function 137 and upon transmission completion of all of the compressed, encrypted blocks to a targeted receiving computer sends an end of transmission signal 152 to sub-function 153 in receiver module 123. The sub-function 141 decrypts any received blocks and temporarily stores each decrypted block via sub-function 145. The receiver end of transmission sub-function 153 controls 154 resident sub-function 146 to initiate the decompression of one or all of the received blocks. Sub-function 147 decompresses one or all of the received blocks and reconstruction sub-function 148 orders and appends the decompressed blocks to reconstruct the original file. Once all of the blocks have been reconstructed into the original file, file handler sub-function 156 accesses the reconstructed file 157 and stores it in a pre-designated location on the target receiving computer.

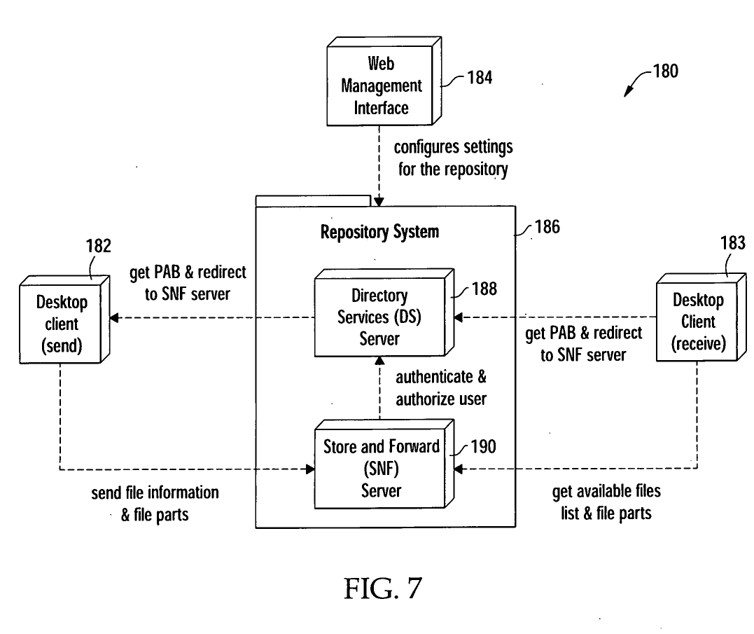

The embodiments of FIGS. 1-6 have described a system employing a sending device and a receiving device. An additional architectural structure may employ a client-server configuration. In such a configuration, a server may direct the transfer from client to client. Within the client-server configuration, file transfers across differing platforms may be achieved. The system, as shown in FIG. 7, may be implemented across three computers. A send client, a receive client and a server. The server may be a third computer attached to the send and receive clients that is configured to provide server applications for the client computers. In such a system, transfer rates may be sped up by the distribution of processes to the server. The system may also implement a method of providing access to other client computers through the use of the server which may provide one client access to other clients.

Turning now to FIG. 7, FIG. 7 shows a high-level architectural diagram for a Java-enabled system 180 according to an aspect of the invention. The system 180 includes a desktop client (send) 182, a desktop client (receive) 183, a web management interface 184, and a repository system 186 which includes a directory services server 188 and a store and forward server (SNF) 190. For the purposes of this description, the terms “directory services server” and “store and forward server (SNF)” are defined as software subsystems and do not necessarily constitute an entire computer system. Also, while the entire repository system 186 can certainly be hosted on a single computer system, the inventors contemplate a scalable repository system that might include several computer systems, possibly located remotely from one another, for running the directory services server 188 and SNF server 190, but sufficiently interconnected via high-speed communications networks if not co-located on a single system. The desktop client (send) 182 communicates with the repository system 186 to transfer files through the repository system 186 to the desktop client (receive) 183. The web management interface 184 configures the settings for the repository system 186. The directory services server 188 receives address book information from the desktop clients 182 and 183 and redirects the desktop clients 182 and 183 to communicate with the store and forward server 190. The store and forward server 190 receives and sends file information and file parts to the desktop clients 182 and 183, and authenticates and authorizes user transfers through communication with the directory services server 188.

In a preferred embodiment, the desktop clients 182 and 183 communicate to the repository via SOAP-based web services. The SOAP-based services are a protocol for exchanging XML-based messages over a computer network. In many instances, the exchange uses the HTTP application layer protocol. SOAP forms the foundation layer of the web services stack, providing a basic messaging framework that more abstract layers can build on. SOAP is an acronym for the Service-Oriented architectural pattern. SOAP is a more beneficial protocol than other distributed protocols such as GIOP/IIOP or DCOM because SOAP works well with network firewalls. Other distributed protocols may be filtered by these firewalls.

The desktop client (send) 182 sends personal address book (PAB) information to the directory services server 188 so that the directory services server 188 may authenticate the users of the file transfer method and authorize the store and forward server 190 to pass files to the desktop client (receive) 183. The desktop client (send) 182 also receives redirection communications from the directory services server 188 so that the desktop client (send) 182 may communicate with the store and forward server 190. The desktop client (send) 182 communicates with the store and forward server 190 to send file information and compressed file parts to the store and forward server 190.

The desktop client (receive) 183 sends personal address book (PAB) information to the directory services server 188 so that the directory services server 188 may authenticate the user receiving the file transfer method and authorize the store and forward server 190 to forward files from the store and forward server 190 to the desktop client (receive) 183. The desktop client (receive) 183 also receives redirection communications from the directory services server 188 so that the desktop client (receive) 183 may communicate with the store and forward server 190. The desktop client (receive) 183 communicates with the store and forward server 190 to receive file information and compressed file parts from the store and forward server 190.

The web management interface 184 is provided by a standard web browser. The web management interface 184 configures settings for the repository. The SOAP based web services may depend on the type of web browser at the client, and thus the web management interface 184 may build the envelope, header and body sections of the SOAP message according to the type of browser at the desktop clients 182 and 183, such as Microsoft Internet Explorer, Mozilla Firefox, Opera, Netscape, Apple Safari and Konqueror. The web management interface 184 may also set other properties of communication and settings within the repository system 186.

The server-side of the system of FIG. 7 is the repository system 186, which is divided into the directory services server 188 and store and forward server 190. These servers 188 and 190 provide two distinctly different roles in the repository. The directory services server 188 provides the functionality to authorize and authenticate users, to pull address book information, and to retrieve information regarding how to communicate with the store and forward server 190. The store and forward server 190 provides a file repository, which understands the file transfer process used by the desktop client 182 or 183. The store and forward server 190 stores transmitted files for users based on system and file settings, and it implements user/group based security for the files.

The system 180 of FIG. 7 creates a cross-platform compatible and operating system agnostic file transfer utility through a client-server architecture. Within this architecture, a dramatic reduction in file/data transfer times may be accomplished. In addition, the web management interface 184 may increase security by locking down security during and after transfer by using a server side application to address role level access and build robust audit trails. The repository system 186 may increase reliability in transfer completion, and add confirmation features to the method. By implementing client access through the browser of the desktop clients 182 and 183, the user may use a familiar, friendly interface.

In a preferred embodiment, the system 180 includes an auto-restart feature within the repository system 186. When an interruption in a transfer occurs, the repository system 186 records the fault at the moment of transmission failure, and automatically restarts the transmission at the point of interruption. The repository system 186 completes the transfer process without the need to retransfer the entire file or group of files. The transfer may then save time, manpower and bandwidth. The repository system 186 also manages both the security and bandwidth limitations by providing compression, encryption, and transfer simultaneously. The repository system 186 transmits multiple compressed files asynchronously.

In a preferred embodiment, the system 180 uses AES 256 bit encryption with SSL methodology as a security measure. Identity authentication is performed using RSA (RC5) 1,024 bit key length handshake, coupled with role-level access to ensure an optimum level of security. The system 180 ensures that files are secure before they move anywhere -inside or outside the enterprise. Files may remain in a compressed and encrypted state in the store and forward server 190 to support storage and data retrieval models, as well as disaster recovery and continuity planning.

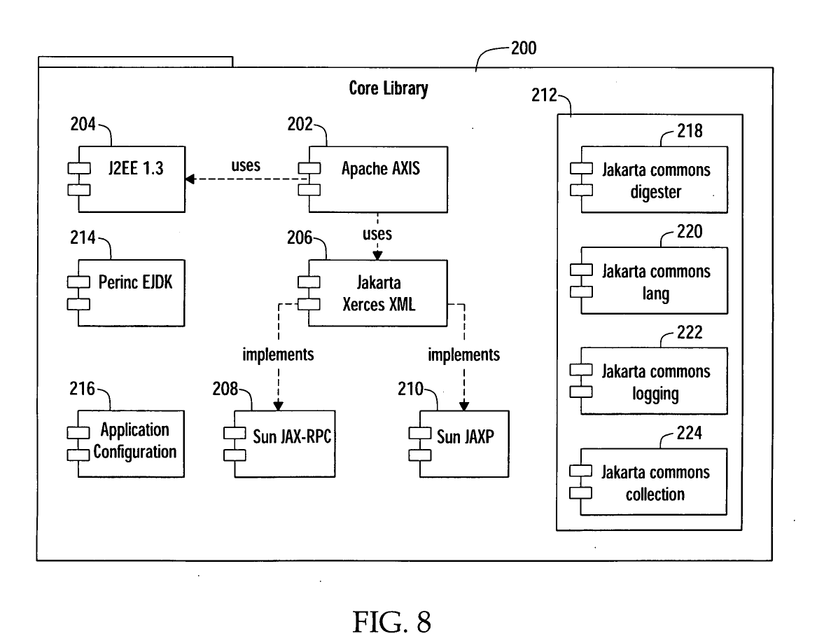

Turning now to FIG. 8, FIG. 8 is a diagram of a core library 200 for the server and desktop applications according to an aspect of the invention. In a preferred embodiment, the core library 200 includes an Apache AXIS framework 202, a J2EE framework 204, a Jakarta Xerces XML framework 206, Sun JAX-RPC 208 and JAXP 210, Jakarta commons APIs 212, a Perinc EJDK 214, and an application configuration 216. Because various technologies and packages are shared between the desktop and server applications, the core library 200 is used to provide a consistent level of functionality.

The Apache AXIS framework 202 is a web services framework provided by the Apache organization. The AXIS framework 202 includes an implementation of the SOAP server. Through various utilities and API's, the AXIS framework 202 may generate and deploy Web service applications. The AXIS framework 202 may be implemented to create interoperable, distributed computing applications. The web services from the AXIS framework 202 reside upon HTTP and other classes from the J2EE framework 204.

The J2EE framework 204 is a programming platform for developing and running distributed multi-tier architecture Java applications, based largely on modular software components running on an application server. The J2EE framework 204 is defined by specifications. The J2EE framework 204 includes several API specifications, such as JDBC, client-side applets, RPC, CORBA, and defines how to coordinate them. The J2EE framework 204 also features some specifications unique to the J2EE framework 204, such as Enterprise Java Beans, servlets, portlets (following the Java Portlet specification), JavaServer Pages and several web service technologies. The file transfer system may then be portable between platforms and scalable, while integrating with legacy technologies.

The Jakarta commons APIs 212 provide common functionality for various design aspects which typically need a similar approach and implementation. The Jakarta commons APIs 212 include a Jakarta commons digester 218, a Jakarta commons lang API 220, a Jakarta commons logging API 222, and a Jakarta commons collection API 224.

The Jakarta commons digester 218 provides developer-friendly, high-level, and event-driven processing of XML documents. The digester 218 also provides functionality based on rule sets triggered by particular patterns within the XML document. The digester 218 may also be useful in parsing configuration files. While other APIs, such as SAX or DOM, also can perform pattern matching functions on XML documents, the digester 218 may perform these pattern matching functions XML documents at a higher level and implements a set of rules once these patterns are found (or not found). An instance of digester 218 is created, the patterns and the rules with it are registered, and the instance is passed to the XML document. The digester 218 then takes over and implements the rules in their registered order. If an element within the document matches more than one rule, all of the rules are implemented for it in the order in which they were registered. The patterns must match the XML elements, based on their name and location in the XML tree.

The digester 218 is prebuilt with a set of 12 rules, which may be extended. When specifying the pattern matching rules, elements are designated as absolute. When a pattern is matched, four callback methods are called within the rules associated with the matched pattern. These methods are begin, end, body, and finish. These are called at the appropriate intervals. For example, begin and end are called when the opening and closing tags of the matched element are found, respectively. The body method is called when the text nested within the matched pattern is encountered, and the finish method is called when the matched pattern has been completely processed. Finally, these patterns can be specified within an external rules XML document (using the digester-rules.dtd) or within the code itself.

The Jakarta commons lang API 220 is an extension of the java.lang package. The Jakarta commons lang API 220 extends the functionality for String manipulations. The functionality of the Jakarta commons lang API 220 extends the default methods provided in the by implementing methods that take more control over String manipulation, numeric methods, and System properties. The Jakarta commons lang API 220 may also provide C-like enumerations. The methods of Jakarta commons lang API 220, mostly static, reduce the coding required for everyday functions, particularly the StringUtils class, which allows you to manipulate strings over and above the methods provided by the standard java.lang.String package.

The StringUtils API of the Jakarta commons lang API 220 lists many other static methods. For example, the class provides methods to create random Strings, which may be useful in creating random passwords. The NumberUtils class provides methods for number manipulations. Interesting methods exist in this class, such as finding the maximum or minimum, and converting Strings to numbers. The NumberRange and CharRange classes provide a way of creating and manipulating ranges of numbers and characters, respectively. The classes in the Builder package provide methods to build toString, hashCode, compareTo, and equals methods for classes which may build quality toString, equals, compareTo, and hashcode methods for classes where method specifications may not be necessary. The Jakarta commons lang API 220 also provides a type-safe Enum data type, like the enum utility in C. The Enum class is abstract, where specifications may be generated by extending this class.

The Jakarta commons logging API 222 is a wrapper library around a set of popular logging implementations used, for instance, when an application requires more than one logging implementation. The Jakarta commons logging API 222 wraps the requirement of 20 logging within a set of standard APIs where the underlying implementation can change or differ. The Jakarta commons logging API 222 is implemented to make the log requests. The Jakarta commons logging API 222 decides, based on available logging architectures, to direct these logging calls to the appropriate handler. Thus, the Jakarta commons logging API 222 may be considered independent of any particular logging implementation.

The Jakarta commons collection API 224 is an extension of the Java Collection Framework extended with data structures, iterators, and comparators. As an example, the Bag interface in the Jakarta commons collection API 224 may implement an element count inside a Bag. Because Bag itself is an interface, an implementing class, such as HashBag or TreeBag, must be used when creating a bag for the HashMap or TreeMap functions, respectively. As another example, the Buffer interface allows you to remove objects from the collection based on a predefined order, such as LIFO (Last In First Out), FIFO (First In First Out), or a user defined order.

Other classes in the Jakarta commons collection API 224 such as the FastArrayList, FastHashMap, and FastTreeMap classes operate in two modes over the corresponding regular Collection classes. The first mode is the “slow” mode, and is ideal for when these classes are being constructed and initialized. During “slow” mode, changes in the structure (addition or deletion of elements) of these classes is synchronized. In the “fast” mode, the access to these classes is thought to be read-only, and therefore is faster, as no synchronization takes place. Structural changes, if required during the fast mode, are accomplished by cloning the existing class, making modifications on the cloned class, and finally, replacing the existing class with the cloned one. These classes are useful in multithreaded environments where most access, after initialization, is read-only.

The iterator package in the Jakarta commons collection API 224 provides iterators for various collections and objects that are not present in the regular Java Collections package. Finally, some useful comparators are provided in the comparator package. A comparator is a class that allows you to define comparing two objects of the same class. For example, in the Buffer class, defining a comparator, may be implemented to impose a sorting order instead of going with the natural sorting of elements.

The Perinc EJDK 214 provides file and directory manipulation, extended test cases, and other features that are not a standard part of J2SE. The application configuration 216 creates an interface to access various property file and XML property packages to configure the applications. Regardless of the implementation, the application configuration 216 provides an interface to access those facilities.

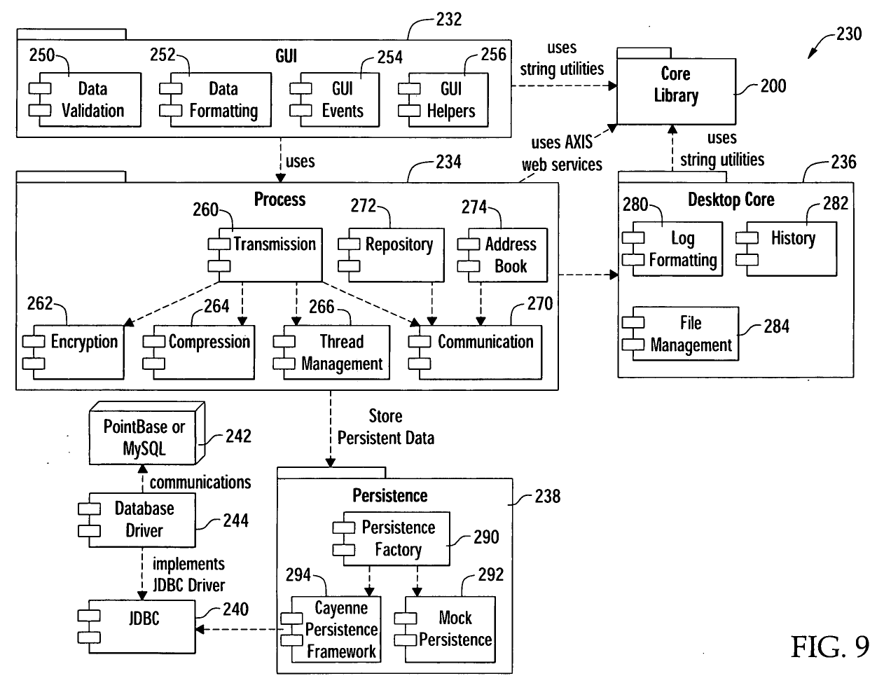

Turning now to FIG. 9, FIG. 9 is a high level architectural diagram of a desktop client 230 of FIG. 7 according to an aspect of the invention. The desktop client 230 includes a graphical user interface (GUI) 232, a process package 234, a desktop core 236 and a persistence package 238. The persistence package 238 communicates with a JDBC driver 240 to access a database 242 through a database driver 244.

The GUI 232 includes a data validation package 250, a data formatting package 252, a GUI events package 254 and a GUI helpers package 256. The data validation package 250 verifies data provided by the user. The data formatting package 252 formats data coming from data sources. Both of these packages use the string and number formatting utilities in the core library 200. The remaining two packages, GUI Events 254 and GUI Helpers 256, delegate events to the process layer appropriate to the data payload.

Preferably, the GUI 232 is built using Swing. Swing is one part of the Java Foundation Classes (JFC) which includes graphical user interface widgets such as text boxes, buttons, split-panes, and tables. Because the GUI widgets are are written in pure Java, they run the same on all platforms, unlike prior GUI development tools which tie the look of the interface to the underlying platform's windowing system. Swing supports pluggable look and feel—not by using the native platform's facilities, but by roughly emulating the platform's look and feel. Such a system allows for uniform behavior on all platforms.

The process package 234 includes a transmission package 260, an encryption package 262, a compression package 264, a thread management package 266, a communication package 270, a repository 272, and an address book 274. All the actual “work” for file transfers is handled by the process package 234. Thus, the process package 234 is preferably designed similar to an API. The transmission package 260 provides functionality for transmitting data packages by implementing the tools of the encryption package 262, the compression package 264, and the thread management package 266. The transmission package 260 also implements the tools of the communication package 270 for directing transmission. The repository package 272 and the address book 274 direct the communication package 270 in managing the communication regarding the transmission. The packages 260-274 are preferably black box testable using an automated testing framework. While the function specific tasks of file transfer are performed in the process package 234, non-function specific tasks are sent to the desktop core package 236, which includes log formatting 280, history management 282, and file management 284.

The desktop core 236 perform non-specific tasks necessary for the implementation of the file transfer system. The desktop core 236 may log faults in the process package 234 using the log formatting package 280. The history package 282 may log system use for recovery purposes and quick access to prior archives. The file management package 284 may manage built files within the desktop client 230.

The persistence package 238 includes a persistence factory 290, a mock persistence 292 and a Cayenne persistence framework 294. The persistence package 238 persists the characteristic of data that outlives the execution of the program that created it. Persistence is achieved in practice by storing the data in non-volatile storage such as a relational database, like the PointBase or MYSQL database 242. The persistence factory 290 controls the persistence within the persistence package 238. The Cayenne persistence framework 294 is a full-featured Java object relational mapping framework. The mock persistence 292 emulates the activity of the Cayenne persistence framework 294 and the relational database 242 as processed through the database driver 244 and the JDBC 240.

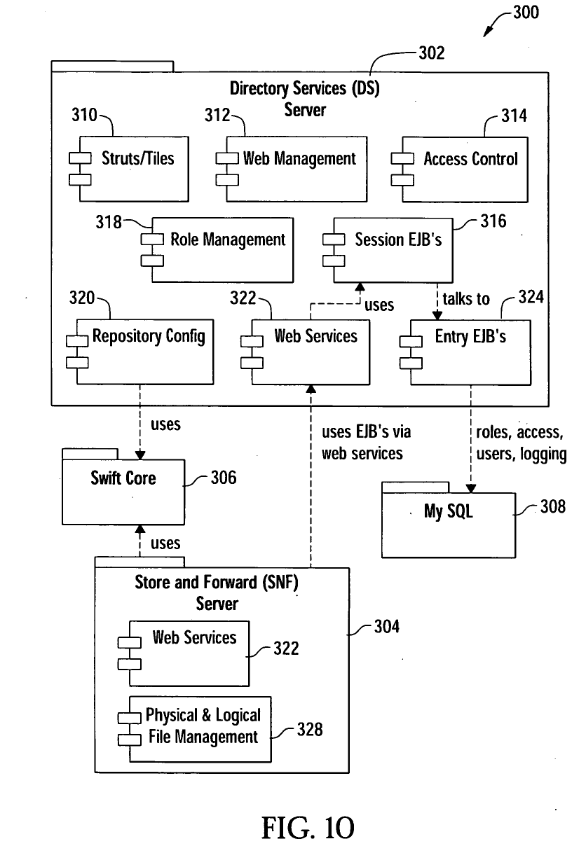

Turning now to FIG. 10, FIG. 10 is a high level architectural diagram of a server side repository system 300 according to an aspect of the invention. The repository system 300 includes a directory services server 302, a store and forward server 304, the core library 200, and a database 308. The directory services server 302 includes a struts and tiles framework 310, a web management package 312, an access control package 314, session enterprise Java beans (EJBs) 316, role management package 318, a repository configuration 320, web services 322 and entity EJBs 324. The store and forward server 304 includes web services 322 and physical and logical file management 328. Using web services 322 as a messaging medium, the repository system 300 is designed to communicate with the desktop client 230.

The repository system 300 is broken into 3 main services: directory, store and forward, and database management. These services ensure consistent security authorization and authentication, provide reliability and scalability features based on industry standards, provide the fastest possible file transfer between the repository system 300 and the desktop clients 230, minimize functionality and data duplication between the directory services 302 and store and forward services 304, and define a clear contract of services between the directory services 302 and store and forward services 304.

The struts and tiles framework 310 provides the foundation for the web management interface 312. This interface 312 manages configurable aspects for the repository system 302. A web based interface may be selected to allow administrators to login from any system with a browser. The web based interface 312 is also thin in terms of network overhead, which is advantageous in the event that an administrator needs to manage the repository system 302 over a dial-up phone line. For the purposes of load management and simplicity, the web management interface312 may be hosted on the directory services 302. In comparison to the store and forward server 304, the CPU and network bandwidth load on the directory services server 302 is expected to be considerably lower.

The directory services 302 handles all tasks associated with users and user security. These tasks include authentication and authorization for a user to read address book information, the list of files a user can download, and the download of a single file part. Regarding the file list and file parts, the directory services only approves access to the system or download of a piece of data. The directory services 302 also handles the tasks of business process rules on user management through the role management 318, access 20 control 314, the session EJBs 316 and the entity EJBs 324. The directory services 302 handles the repository configuration 320 so that the directory services 302 and the store and forward server 304 may be managed and the processes of the repository system 300 may perform the methods of the file transfer system. The directory services 302 also hosts the web management interface 312 which allows an administrator to manage the operation of the file transfer system. In an alternative embodiment, the web management interface 312 may be separated from the directory services 302.

The primary function of the store and forward server 304 is to transmit data in the fastest possible manner to and from desktop clients 230. To help optimize this process, all non-essential file transfer services have been removed or delegated to the directory services server 302. The web services 322 in the store and forward server 304 enables communication between the store and forward server 304 and the desktop clients 230.

Data storage services for the store and forward server 304 is handled and hosted by the directory services server 302 for a few reasons. EJB entity and session beans 316 and 324 are used due to the enterprise requirements for the persistence layer. Because EJBs are hosted in a J2EE container, the three options for implementing this hosting are to put them on the directory services server 302, put them on the store and forward server 304, or put them on a completely separate system. Again, the directory services server 302 may be used since the server load is not expected to be critically high for most installations. The EJB layer can also be offloaded and scaled as needed per the J2EE specification. The EJBs and MySQL database 308 provide data storage services for the directory services server 302 and the store and forward server 304.

The secure transfer of enterprise data using environments that include data updates, backups, archiving, SAN, and data warehouse/mart transfers are addressed in the systems and methods of the invention. Demands for security are protected from three separate, but important perspectives. First, communication (user access to components of the file transfer system) are limited. Second, the storage components archiving and deletion services are reviewed. Third, auditing of information through historic transactional information is maintained.

The communication components support a user-to-service configuration, typically a desktop computer connected to a server. Security for this configuration is threefold, involving authentication, access, and encryption. Every connection between a user and repository server 300, or server to server, is secure/encrypted using Hypertext Transfer Protocol over Secure Socket Layer (HTTP over SSL, or “HTTPS”). Every user and administrator must login to the repository server 300 using a unique user ID and password. The repository system 300 authenticates the user with these specific identifying elements. Without a valid user ID and password, it is not possible to access the repository system 300 or any data it manages.

After a user is authenticated, system security measures restrict access and functional capability based on roles and groups through role management 318. Every user and administrator is assigned to at least one role/group at initial user setup. The role defines what information the user can access, and what functions the user can perform, e.g., send, or send & receive. A user or administrator cannot access data or functions if his/her role restricts such access or capability.

Every user and administrator authenticated and assigned to a role may perform functions allowed by his/her role. In a preferred embodiment, each user has a unique RC5-64 1024-bit key. The bit key technology was developed by RSA Security Inc. The RC5-64 1024-bit key for each user is system-generated, and is used to encrypt each file the user manipulates (sends/receives) using the 256-bit Advanced Encryption Standard (ABS) Rijndael block cipher. (AES)Rijndael is a NIST -approved encryption methodology such that every folder, file or segment of data sent or received by the repository system 300 is protected by a state-of-the-art encryption method. These communication components provide a “first layer,” ensuring that only valid users can access the system, that data functions are protected from misuse, and that data sent or received is secure from theft and/or hacking.

The storage components take advantage of resident OS file system functions, and add GUID 128-bit labels to obscure folder, file, and file part identities. The secure database 308 protects all file identifiers and their relationships. Storage involves resident OS file system functions, file name obscurity, and deletion functions.

The files sent or received by the repository system 300 are stored using the resident operating system file system. Most operating systems have the capability to encrypt files for storage. The repository system 300 does not override the OS file system encryption function, but takes advantage of it to further protect stored files.

File name security further enhances the protection of information. The repository system 300 uses GUIDs to further protect information, assigning a 128-bit unique string of characters at three different levels: folder, file, and file part. The repository system 300 assigns a GUID to every folder, to every file within the folder, and to every piece of every file in every folder. The dividing of data into small pieces, each identifiable by a specific GUID makes unauthorized access less likely to result in an intelligible file. The physical and logical file management 328 maintains the “map” of how these GUIDs relate in its secure database—in an encrypted file. Thus, even if all the folders, files and parts of a particular transmission are somehow compromised, it would be virtually impossible to “piece together” the transmitted file without also having the GUID map, which is held in an encrypted file, securely stored on a database that allows no remote entry, only local access.

The final component of secure transmission is proper deletion within the repository system 300 of the files transferred. Deletion protects against such files being “recovered” from the storage medium. The repository system 300 may use standard deletion methods, coupled with the GUIDs used for data storage to create a deletion process that limits recovery of useful data. When a file is deleted, the repository system 300 marks the file for deletion. A deletion job within the repository system 300 then removes the file identification records from file tables in the database, essentially destroying any reference to the file that relates it to any other file or data. Finally, the resident OS file deletion process removes the file from the storage medium. While the actual file may still remain on the storage medium, its relevant reference to other files, folders or file parts has been removed. There is no means by which the file can be easily related to any other file.

These storage components add an additional layer of security, encrypting and storing data quickly while creating a security screen that makes re-creation of meaningful data improbable. The deletion process protects data from discovery by further obscuring any context or relation to other data.

The final distinct element of security within the system involves an auditing function. The repository system 300 audit functions ensure that every transmission—every file sent or received—is logged as part of an audit database. This log ensures accountability for every function, provides a level of version control, and ensures that user and administrative actions can be traced to a valid system user ID.

The audit log includes a who, what, when, where, and how of transmission. The log determines who the user under which the transmission took place is. The audit log logs what was sent, such as the folder, file, or file parts sent or received as part of the transmission. The date and time the transmission was sent or received, the “When,” is also logged in the audit log. The client IP address/server IP address where a received transmission was sent from, or where a sent transmission was sent may also be logged. Finally, how the transmission was achieved, namely what application was used for the transmission is logged in the audit log. Every transmission is logged, regardless of whether sent/received by a regular user, system administrator, of anyone else.

The audit log provides a security trail of every function performed by the repository system 300. A system administrator with a valid administrator's ID and login can access the audit database to review all activity. Preferably, no user or administrator can update, edit, or delete any information in the audit log. The log is maintained on the repository system 300 and allows only local access.

One of the difficulties in coding the disclosed invention pertains to the asynchronous execution of various of the above identified modules and sub-functions, as well as others. Asynchronous execution of sub-processes relies upon the ability to spawn multiple threads and attach them to different functions and processes. Below are listed some example processes that are asynchronous in the disclosed invention:
File Status Monitoring
Block Compression
File Splitting (i.e. segmentation)
Communications Authentication
Transmission Initiation
File Block Transmission
Sending an End of Transmission Signal
File Reconstruction
File Storing

One of the problems encountered in the design of the herein described system is that available threads in any particular thread pool for a particular invoked application are exhausted quickly, thereby causing processing deadlocks during execution. The deadlocks occur due to the processes, along with the underlying .NET framework, exhausting all the threads in the available thread pool. Obviously, the inventors had no wish to limit the number of threads available for any running module or sub-function to allow for the most efficient processing of files. This was solved by implementing a queued based system based upon an asynchronous timer. The timer is used to check various queues within the system based on a known time interval. For example, a selected system timer governs when to check for any available file blocks that are awaiting compression. Every 50 milliseconds the system spawns an asynchronous thread that checks the compression queue. If a message is found in the queue, it is popped and processed asynchronously utilizing the same thread generated from the timer function. An asynchronous queued timer system allows for easy configuration and management of executing process threads. In this manner, the number of executing threads in process at any instant can be monitored and controlled through a shared member. For example, the transmission sub-function 137 (See FIG. 6) can be limited to ten simultaneous file transmissions.

Such an asynchronous queuing system adds to the fault tolerance of the invention. For example, if a transmission process initiated from the top of the queue fails due to, say, a network error, the same failed process can be placed at the bottom of the queue for re-initiation.

Another challenge faced in the asynchronous multi-threading environment of the present invention is synchronization. Many objects in the .NET framework are, or are easily made, “thread-safe.” That is, a synchronized queue object handles both reading and writing of data and ensures that the same memory is not accessed by two different threads simultaneously. The “queue object” used in the system is an example of such a sub-process. Some objects, for example “Data-Sets,” which are used to maintain state throughout a file transmission are not thread-safe, which can lead to random timing issues arising with regard to threading and datasets. This can be remedied, by using the .NET SyncLock capabilities where are part of the .NET command set. A “Sync-Lock Block” command can be assigned to a particular process to ensure that code inside the process is not executed by more that one process thread simultaneously. In this manner, variously executed asynchronous processes can be sync-locked to avoid problems in asynchronous thread executions.

While I have shown my invention in one form, it will be obvious to those skilled in the art that it is not so limited but is susceptible of various changes and modifications without departing from the spirit thereof.

Having set forth the nature of the present invention, what is claimed is:

1. A file transfer system, comprising:
a. a first server configured to communicate with a first client to direct an asynchronous file transfer from said first client to a second client such that the file to be transferred is partitioned into a plurality of file parts;
b. a second server configured to receive said plurality of file parts asynchronously, said second server further configured to send said plurality of file parts to said second client; and
c. said first server configured to verify said second client is allowed to receive said plurality of file parts and further configured to direct said second server to send said plurality of file parts to said second client.

2. The file transfer system of claim 1, wherein said first server is further configured to authenticate said first client.

3. The file transfer system of claim 2, wherein said first server is further configured to receive personal address book information from said first client.

4. The file transfer system of claim 3, wherein said first server is further configured to authorize said first client.

5. The file transfer system of claim 4, wherein said first server is further configured to authorize said second client.

6. The file transfer system of claim 5, wherein said second server is configured to receive a file name from said first server.

7. The file transfer system of claim 6, wherein said second server is further configured to store said file parts.

8. The file transfer system of claim 7, wherein said second server is further configured to associate said file parts from said first client with said file name from said first client.

9. The file transfer system of claim 8, wherein said second server is further configured to send a list of available file names to said second client.

10. The file transfer system of claim 9, wherein said second server is configured to receive a request for a file from said second client, wherein said file is a file listed in said list of available file names.

11. The file transfer system of claim 10, wherein said second server is further configured to send said file parts associated with said requested file to said second client.

12. The file transfer system of claim 1, wherein said first server is further configured to direct the compression of said file parts at said first client.

13. The file transfer system of claim 12, wherein said first server is further configured to direct the encryption of said file parts at said first client.

14. A file transfer client, comprising:
a. an interface configured to display data for transferring a file;
b. a process layer configured to asynchronously transfer said file to a central repository, said process layer configured to split said file into file parts smaller than said file; and
c. said process layer configured to receive direction from said central repository on transference of said file parts to a repository folder designated to a second transfer client.

15. The file transfer client of claim 14, wherein said process layer includes:
a. means for extracting a block from said file to replicate a portion of said original file data;
b. means for compressing said extracted block;
c. means for transmitting said compressed block and ordering data indicia to said central repository; and,
d. means for iteratively and asynchronously initiating said extracting means and said compressing means until all of said file has been extracted into blocks, each block compressed, and each compressed block transmitted to said central repository.

16. The file transfer client of claim 15, wherein said encryption package is configured to encrypt said file parts using a 256 bit encryption.

17. The file transfer client of claim 15, wherein said process layer further comprises a communication module configured to authenticate said transfer client to said central repository.

18. The file transfer client of claim 17, wherein said communication module authenticates said transfer client with a 1,024 bit key length handshake.

19. The file transfer client of claim 18, wherein said process layer further comprises a compression module configured to compress said file.

20. The file transfer client of claim 15, wherein said process layer further comprises a compression module configured to compress said file parts.

21. The file transfer client of claim 15, further comprising a history module configured to list files transferred and received from said central repository.

22. The file transfer client of claim 15, further comprising an address book configured to pass receiving information to said central repository.

23. The file transfer client of claim 22, wherein said address book is configured to order recipients in groups.

24. The file transfer client of claim 15, wherein said process layer further comprises a local repository configured to receive asynchronously file parts from said central repository.

25. A method for transferring files, comprising the steps of:
a. communicating with a first client to direct an asynchronous file transfer from said first client to a second client such that the file to be transferred is partitioned into a plurality of file parts;
b. verifying said second client is allowed to receive said plurality of file parts; receiving said plurality of file parts asynchronously; and
c. sending said plurality of file parts asynchronously through a central repository to said second client.

26. The method for transferring files of claim 25, further comprising the steps of:
a. extracting a block from said file to be transferred to replicate a portion of original file data;
b. compressing said extracted block;
c. transmitting said compressed block and ordering data indicia to said central repository; and
d. iteratively and asynchronously repeating steps a-d until all of said original file has been fully extracted into blocks, each block compressed, and each compressed block transmitted to said central repository.

27. The method for transferring files of claim 26, further comprising the step of receiving personal address book information from said first client.

28. The method for transferring files of claim 27, further comprising the step of authorizing said first client.

29. The method for transferring files of claim 28, further comprising the step of authorizing said second client.

30. The method for transferring files of claim 29, further comprising the step of receiving a file name from said first client.

31. The method for transferring files of claim 30, further comprising the step of storing said file parts.

32. The method for transferring files of claim 31, further comprising the step of associating said file parts from said first client with said file name from said first client.

33. The method for transferring files of claim 32, further comprising the step of sending a list of available file names to said second client.

34. The method for transferring files of claim 33, further comprising the step of receiving a request for a file from said second client, wherein said file is a file listed in said list of available file names.

35. The method for transferring files of claim 34, further comprising the step of sending said file parts associated with said requested file to said second client.

36. The method for transferring files of claim 25, further comprising the step of directing the compression of said file parts at said first client.

37. The method for transferring files of claim 36, further comprising the step of directing the encryption of said file parts at said first client.

38. A method for transferring a file to a central repository, comprising the steps of:
a. displaying data for transferring a file;
b. dividing said file into file parts smaller than said file;
c. receiving information from said central repository, said information directing a process layer where to send said file parts; and
d. transferring asynchronously said file parts to said central repository.

39. The method for transferring a file to a central repository of claim 38, further comprising the steps of:
a. extracting a block from said file to be transferred to replicate a portion of original file data;
b. compressing said extracted block;
c. transmitting said compressed block and ordering data indicia to said central repository; and
d. iteratively and asynchronously repeating steps a-d until all of said original file has been fully extracted into blocks, each block compressed, and each compressed block transmitted to said central repository.

40. The method for transferring a file to a central repository of claim 39, further comprising the step of encrypting said file parts using a 256 bit encryption.

41. The method for transferring a file to a central repository of claim 39, further comprising the step of authenticating the identity of a first client to the central repository.

42. The method for transferring a file to a central repository of claim 41, further comprising the step of authenticating said first client with a 1,024 bit key length handshake.

43. The method for transferring a file to a central repository of claim 39, further comprising the step of listing files transferred and received from said central repository.

44. The method for transferring a file to a central repository of claim 43, further comprising the step of accessing an address book configured to pass receiving information to said central repository.

45. The method for transferring a file to a central repository of claim 44, further comprising the step of ordering recipients in groups in said address book.

46. The method for transferring a file to a central repository of claim 45, further comprising the step of receiving asynchronously file parts from said central repository.
